(19) United States
(12) Patent Application Publication
(10) Pub. No.: US 2016/0124620 A1
(43) Pub. Date: May 5, 2016

(54) METHOD FOR IMAGE DELETION AND DEVICE THEREOF

(71) Applicant: Xiaomi Inc., Beijing (CN)

(72) Inventors: Xiehao BAO, Beijing (CN); Dongya JIANG, Beijing (CN); Wankun YANG, Beijing (CN)

(73) Assignee: Xiaomi Inc., Beijing (CN)

(21) Appl. No.: 14/826,685

(22) Filed: Aug. 14, 2015

Related U.S. Application Data
(63) Continuation of application No. PCT/CN2015/075161, filed on Mar. 26, 2015.

(30) Foreign Application Priority Data
Oct. 29, 2014 (CN) 201410592315.X

(51) Int. Cl. G06F 3/0484; G06T 3/40; G06F 3/0488

(52) U.S. Cl. CPC G06F 3/04845; G06F 3/0488; G06F 3/04842; G06T 3/40; G06T 2200/24

(57) ABSTRACT

The present disclosure discloses a method and a device for image deletion. In the method, when displaying an image in a full-screen mode, the device presents a first object on a screen hidden under the displayed image. The device receives a zoom-out operation signal and zooms out the image displayed on the screen, where the zoom-out operation signal may be generated when the screen is touched according to a predetermined track. When the image is zoomed out to be inside the first object and satisfies a deleting condition, the device deletes the image.

### CROSS-REFERENCE TO RELATED APPLICATIONS

The present application is a continuation of International Application No. PCT/CN2015/075161, filed Mar. 26, 2015, which is based upon and claims priority to Chinese Patent Application No. 201410592315.X, filed Oct. 29, 2014, the entire contents of which are incorporated herein by reference.

### TECHNICAL FIELD

The present disclosure generally relates to the field of image processing, and more particularly, to a method for image deletion and a device thereof.

### BACKGROUND

In an image gallery of a terminal, various photographed or collected images may be stored. Due to limited storage space of the terminal, selective deletion of images in the image gallery sometimes is needed.

When a picture is viewed in a full-screen mode, typically, all menu buttons are hidden. To delete an image, a user firstly tap a center of the screen to call out the menu buttons, and then tap a “delete” button among the menu buttons. At this time, the terminal may pop out a prompt box for confirmation. If the user taps a “confirm” button in the prompt box, the terminal deletes the image displayed on the current screen.

### SUMMARY

Embodiments of the present disclosure provide a method and a device for image deletion. The technical solutions are as follows.

According to a first aspect of embodiments of the present disclosure, there is provided a method for image deletion. The method include: when a device displays an image in a full-screen mode, the device presents a first object on a screen hidden under the displayed image, where the first object has an area smaller than an area of the screen. The device receives a zoom-out operation signal when the screen is touched according to a predetermined track. The device zooms out the image displayed on the screen. The device deletes the image when the image is zoomed out to be at least partially inside the first object and satisfies a deleting condition.

According to a second aspect of embodiments of the present disclosure, there is provided a device for image deletion, including: a processor; and a memory for storing instructions executable by the processor. The processor is configured to perform: when displaying an image in a full-screen mode, presenting a first object on the screen hidden under the displayed image, where the first object includes an area smaller than an area of the screen. The processor is configured to receive a zoom-out operation signal, and zoom out the image displayed on the screen, where the zoom-out operation signal is generated when the screen is touched according to a predetermined track. When the image is zoomed out to be at least partially inside the first object and satisfies a deleting condition, the processor is configured to delete the image.

According to a third aspect of embodiments of the present disclosure, there is provided a non-transitory readable storage medium comprising instructions, executable by a processor in a terminal, for performing a method acts including: when displaying an image in a full-screen mode, presenting a first object on a screen hidden under the displayed image, the first object having an area smaller than an area of the screen; receiving a zoom-out operation signal, and zooming out the image displayed on the screen, the zoom-out operation signal being generated when the screen is touched according to a predetermined track; and when the image is zoomed out to be at least partially inside the first object and satisfies a deleting condition, deleting the image.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for image deletion according to exemplary embodiments of the disclosure;

FIG. 2A is a flow chart of a method for image deletion according to exemplary embodiments of the disclosure;

FIG. 2B is a schematic diagram of a first object presented on a screen according to exemplary embodiments of the disclosure;

FIG. 2C is a schematic diagram of an operation when a zoom-out operation signal is generated according to exemplary embodiments of the disclosure;

FIG. 2D is a schematic diagram showing image deletion according to exemplary embodiments of the disclosure;

FIG. 3A is a flow chart of a method for image deletion according to exemplary embodiments of the disclosure;

FIG. 3B is a schematic diagram of a first object and a second object presented on a screen according to exemplary embodiments of the disclosure;

FIG. 3C is a schematic diagram showing image deletion according to exemplary embodiments of the disclosure;

FIG. 4 is a block diagram of a device for image deletion according to exemplary embodiments of the disclosure;

FIG. 5 is a block diagram of a device for image deletion according to exemplary embodiments of the disclosure;

FIG. 6 is a block diagram of a device for image deletion according to exemplary embodiments of the disclosure; and

FIG. 7 is a block diagram of a device for image deletion according to exemplary embodiments of the disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

There are a few issues in the related arts. For example, during image deletion, a user needs to tap too many buttons and the position of each tap is different, thereby resulting in rather troublesome operations.

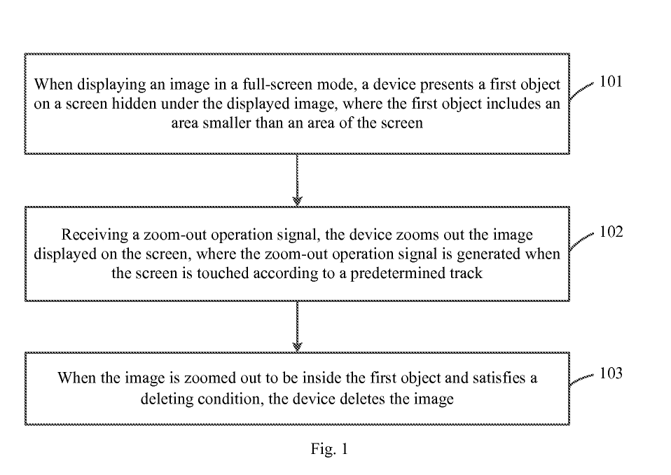

FIG. 1 is a flow chart of a method for image deletion according to exemplary embodiments of the disclosure. As shown in FIG. 1, the method for image deletion may include the following steps implemented in a mobile device.

In step 101, when an image is displayed in a full-screen mode, a first object is presented on a screen. The first object has an area smaller than an area of the screen.

Generally, the first object may have any shape. For example, the first object may be a prompt box hidden behind the image displayed on the screen. Since the first object is hidden behind the image displayed in the full-screen mode, the first object is invisible from the screen.

In step 102, a zoom-out operation signal is received, and the image displayed on the screen is zoomed out. The zoom-out operation signal is generated when the screen is touched according to a predetermined track.

The predetermined track may be a preset track. For example, it may be a track generated when two touch points which are simultaneously generated upon touch of the screen approach each other, or may be a track when a position of a first touch point keeps fixed and a second touch point gets close to the first touch point. The device may first receive the zoom-out operation signal when the screen is touched according to a predetermined track. The device may zoom out the displayed image according to the zoom-out operation signal.

In step 103, when the image is zoomed out to be at least partially inside the first object and satisfies a deleting condition, the image is deleted.

Accordingly, in the method for image deletion provided by the embodiments of the present disclosure, an image is deleted when the image is zoomed out to be inside a presented first object and satisfies a deleting condition. The first object may include a prompt box or a different shape. Since the image is deleted as long as the image is zoomed out to be inside the first object by touch of the screen and satisfies the deleting condition, there is no need to tap various buttons involved in deletion of the image. Thus, the method may solve the problem that during image deletion, a user needs to tap too many buttons and the position of each tap is different, thereby resulting in rather troublesome operations. Consequently, the method reduces the operation difficulty greatly, and thereby the deletion operation becomes simple and easy.

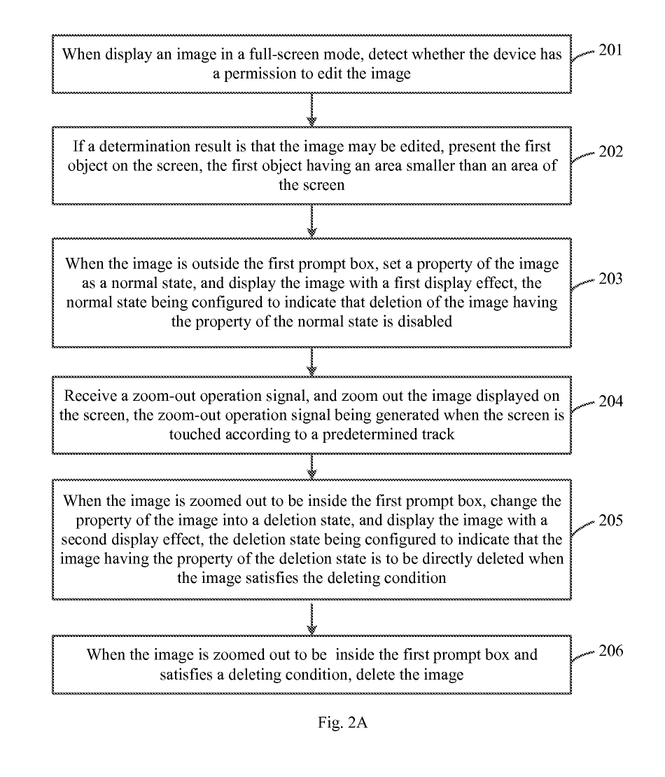

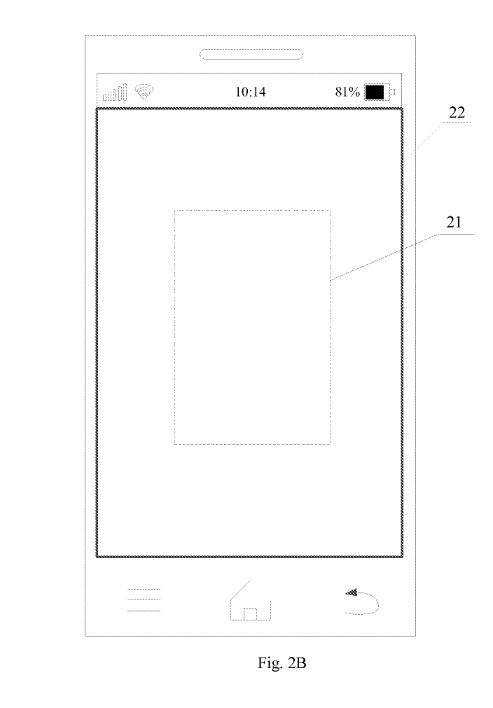

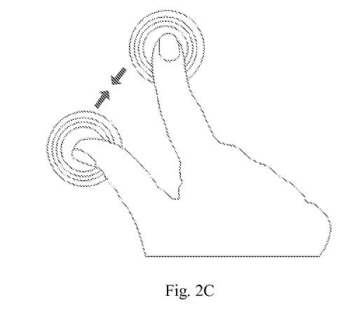

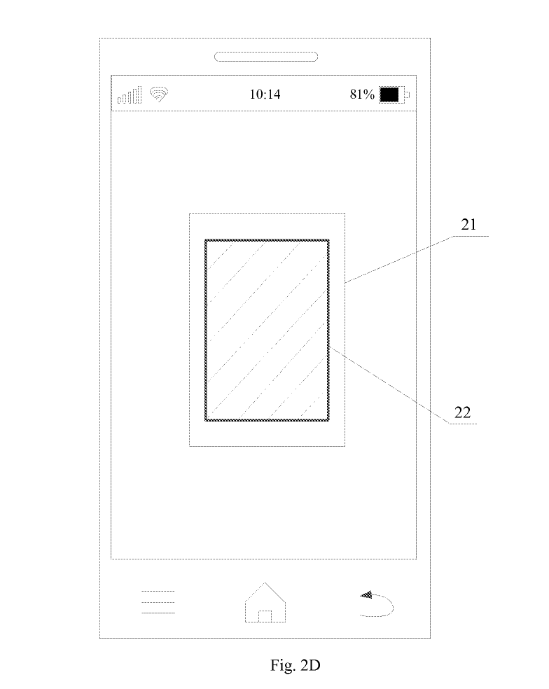

In a practical implementation scenario of image deletion, one prompt box may be presented on the screen. When the image is zoomed out to be inside the prompt box and satisfies the deleting condition, the image is directly deleted. For details, refer to the specific description regarding FIG. 2A.

FIG. 2A is a flow chart of a method for image deletion according to exemplary embodiments of the disclosure. As shown in FIG. 2A, the method for image deletion may include the following steps implemented in a device includes a hardware processor and a non-transitory storage accessible to the hardware processor.

In step 201, when an image is displayed in a full-screen mode, the device determines whether the device has permission to edit the image.

If the image is displayed in a full-screen mode and is permitted to be edited, it means that the image may be operated, for example, may be zoomed out, moved, etc.

In step 202, if a determining result is that the image may be edited, the device may present a first object on a screen. The first object may include a prompt box having an area smaller than an area of the screen.

The first prompt box, as a condition for image deletion, generally has an area smaller than an area of the screen.

Generally, the first prompt box is smaller than the image displayed in the full-screen mode, and may be hidden behind the image displayed on the screen. Since the first prompt box is behind the image displayed in the full-screen mode, the first prompt box is invisible from the screen.

Referring to FIG. 2B, it is a schematic diagram of a first prompt box presented on a screen according to exemplary embodiments. As shown in FIG. 2B, a box denoted by a dash line is the first prompt box 21. The dash line denotes that the first prompt box 21 is behind the full-screen image 22 (in order to show the positional relationship between the image 22 and the first prompt box 21, pixel contents in the image 22 are omitted). At this time, the first prompt box 21 is invisible. Obviously, the first prompt box 21 has an area smaller than that of the screen.

In practical implementation, since the image generally has a rectangular shape, the first prompt box may also have a rectangular shape. Obviously, the first prompt box may have other shapes such as an elliptical shape or a polygonal shape. The shape of the first prompt box is not specifically restricted in the embodiments.

Alternatively or additionally, the first prompt box may be presented at a central position of the screen, that is, the first prompt box has a central position coinciding with the central position of the screen. Obviously, the first prompt box may be at a position other than the central position of the screen. The specific position of the first prompt box is not restricted in the embodiments.

In step 203, when the image is outside the first prompt box, a property of the image is set as a normal state, and the image is displayed with a first display effect. The normal state is configured to indicate that deletion of the image having the property of the normal state is disabled.

The first display effect may be set in any form. Alternatively or additionally, the first display effect may be a default display effect when the image is in an editable state. The first display effect is not specifically restricted in the present disclosure.

When the image is editable and is outside the first prompt box, the property of the image is set as the normal state. In the normal state, deletion of the image is disabled. That is, the normal state is configured to indicate that deletion of the image having the property of the normal state is disabled. In other words, when the image is outside the first prompt box and is editable, if a user operates on the image and the user's fingers leave the screen or the image satisfies other deleting conditions, the image is not deleted, and a default operation is performed.

In step 204, a zoom-out operation signal is received, and the image displayed on the screen is zoomed out. The zoom-out operation signal is generated when the screen is touched according to a predetermined track.

The zoom-out operation signal is generated when a user touches the screen according to a predetermined track. In practical application, the zoom-out operation signal may be generated when the user touches the screen with two fingers according to a predetermined track.

For example, the zoom-out operation signal may be generated when the user touches the screen by moving two fingers toward each other according to a predetermined track. That is, a user may touch the screen simultaneously with two fingers, and touch points of the two fingers on the screen become gradually closer. Referring to FIG. 2C, it is a schematic diagram of an operation when a zoom-out operation signal is generated according to exemplary embodiments. In FIG. 2C, two fingers touch the screen, and both fingers move toward each other while touching the screen.

Obviously, the zoom-out operation signal may also be generated when a user touches the screen with one, two or four fingers according to other predetermined tracks. The generation manner of the zoom-out operation signal is not restricted in the present disclosure.

In step 205, when the image is zoomed out to be inside the first prompt box, the property of the image is changed into a deletion state, and the image is displayed with a second display effect. The deletion state is configured to indicate that the image having the property of the deletion state is to be directly deleted when the image satisfies the deleting condition.

The deleting condition is that a deleting signal is received, or a time period since the image is zoomed out to be inside the first prompt box reaches a predetermined time period.

The deleting signal is generated when the screen is changed from a state in which the screen is touched to a state in which the screen is not touched. In other words, since during the process of zooming out the image, the screen is always being touched, the deleting signal is generated when the users' fingers leave the screen from touching the screen.

When the image is zoomed out to be inside the first prompt box according to the zoom-out operation signal, the property of the image is changed into the deletion state. Since the deletion state is configured to indicate that the image having the property of the deletion state is to be directly deleted when the image satisfies the deleting condition, in the deletion state, the image is allowed to be directly deleted when the image satisfies the deleting condition.

In order to make a user easily learn about that the property of the image is the deletion state, the image in the deletion state may be displayed with the second display effect. For example, the image in the deletion state may be displayed with a highlighted effect or a blurred effect. In this way, the user may determine whether to delete the image after the image is displayed with the second display effect.

In order to facilitate user's judgment about when the image may be deleted, the first display effect and the second display effect are generally two different display effects. For example, the first display effect is a default display effect, and the second display effect is a highlighted masking effect or a blurred masking effect.

In step 206, when the image is zoomed out to be inside the first prompt box and satisfies a deleting condition, the image is deleted.

That is, when the image is zoomed out to be inside the first prompt box, and when user's fingers leave the screen from touching the screen (that is, when the screen is changed from a state in which the screen is touched to a state in which the screen is not touched) or a time period since the image is zoomed out to be inside the first prompt box reaches a predetermined time period, the electronic determines that the image satisfies the deleting condition, and the image is deleted at this time.

It may be seen from above that, if a user intends to delete an image displayed in a full-screen mode, he may touch and slide on the screen with his two fingers to zoom out the image to be inside the first prompt box, then the user's two fingers leave the screen, and the image is deleted consequently. Or, a user may touch and slide on the screen with his two fingers to zoom out the image to be inside the first prompt box, keep the image inside the first prompt box for a predetermined time period, and the image is deleted consequently. To delete an image displayed in a full-screen mode, a user may only need to touch and slide on the screen according to a predetermined track corresponding to the zoom-out operation signal and then makes his fingers leave the screen, or, the user may only need to touch and slide on the screen according to a predetermined track corresponding to the zoom-out operation signal and then keep the image inside the first prompt box for a predetermined time period. The operation is simple without unnecessary button-pressing operations, and thereby image deletion is easy to implement.

For example, still referring to FIG. 2B, the first prompt box 21 is presented on the screen (invisible at this time, denoted by the dash line), the image 22 is displayed on the screen in a full-screen mode. When the image 22 is zoomed out to be inside the first prompt box 21 by touch of the screen through the user's fingers, referring to FIG. 2D, the first prompt box 21 is visible at this time, the image 22 is displayed with the highlighted effect. At this time, if the user's fingers leave the screen, or the image 22 is kept inside the first prompt box 21 for the predetermined time period, the image 22 is deleted.

It should be noted that, after the image is deleted, the presented first prompt box may not be displayed any more, or the first prompt box may be removed in order to prevent the user from deleting a next image inadvertently.

In another possible implementation scenario, when the image is zoomed out to be inside the first prompt box, a deleting prompt message may be popped out on the screen. The deleting prompt message is configured to prompt that the image is to be deleted when the screen is changed from a state in which the screen is touched to a state in which the screen is not touched, or to prompt that the image is to be deleted after the predetermined time period is reached. In this way, the deleting prompt message may provide a deleting guide for the user, prompting the user to release the screen to delete the image according to the deleting prompt message, or to keep the image inside the first prompt box for the predetermined time to delete the image. Thereby, it is ensured that the user may be provided with more prompt messages and more options in image deletion, and thereby user experience is improved.

Accordingly, in the method for image deletion provided by the embodiments of the present disclosure, when an image is displayed in a full-screen mode, a first prompt box is presented, and the image is deleted when the image is zoomed out to be inside the presented first prompt box and satisfies a deleting condition. Since the image is deleted as long as the image is zoomed out to be inside the first prompt box by touch of the screen and satisfies the deleting condition, there is no need to tap various buttons involved in deletion of the image. Thus, the method may solve the problem that during image deletion, a user needs to tap too many buttons and the position of each tap is different, thereby resulting in rather troublesome operations. Consequently, the present disclosure reduces the operation difficulty greatly, and thereby the deletion operation becomes simple and easy.

In a possible implementation, the electronic device may also determine whether the image is zoomed in to a size of predetermined multiples of the original image, and if it is determined that the image is zoomed in to the size of the predetermined multiples of the original image, the image is deleted. In other words, if a user intends to delete an image, he may also zoom in the image, and after the image is zoomed in to predetermined multiples of the original image, the image may be directly deleted.

Alternatively or additionally, the electronic device determines whether the image is zoomed in to a size of predetermined multiples, and if it is determined that the image is zoomed in to the size of the predetermined multiples, the electronic device determines whether the deleting condition is satisfied. Here, the deleting condition is: a deleting signal is received, or a time period during which the image is kept in the size of the predetermined multiples reaches a predetermined time period. Also, the deleting signal is generated when the screen is changed from a state in which the screen is touched to a state in which the screen is not touched.

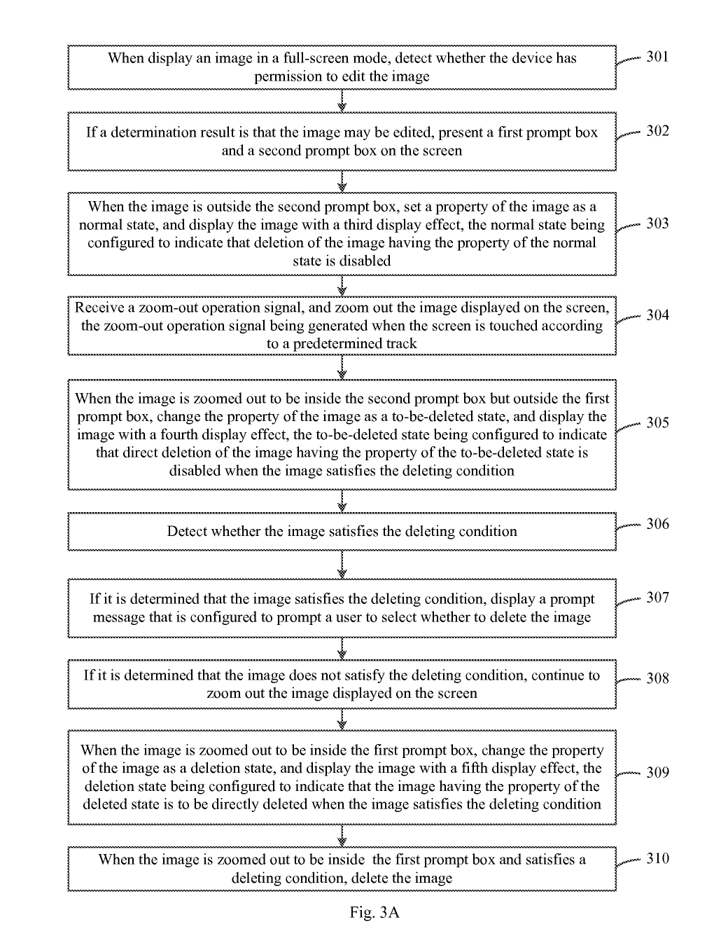

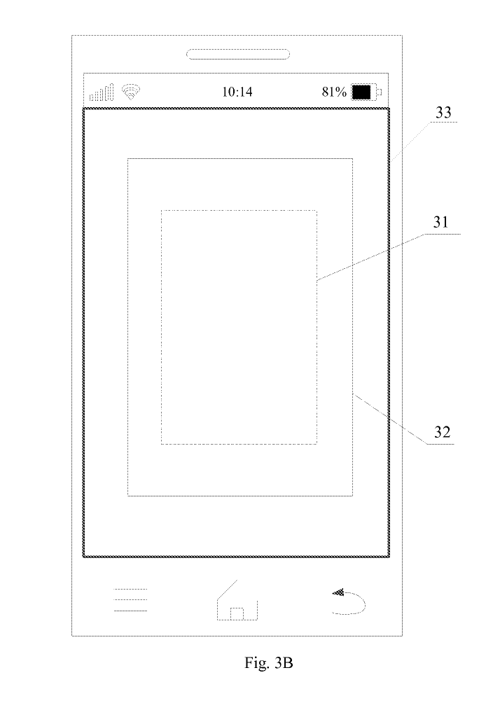

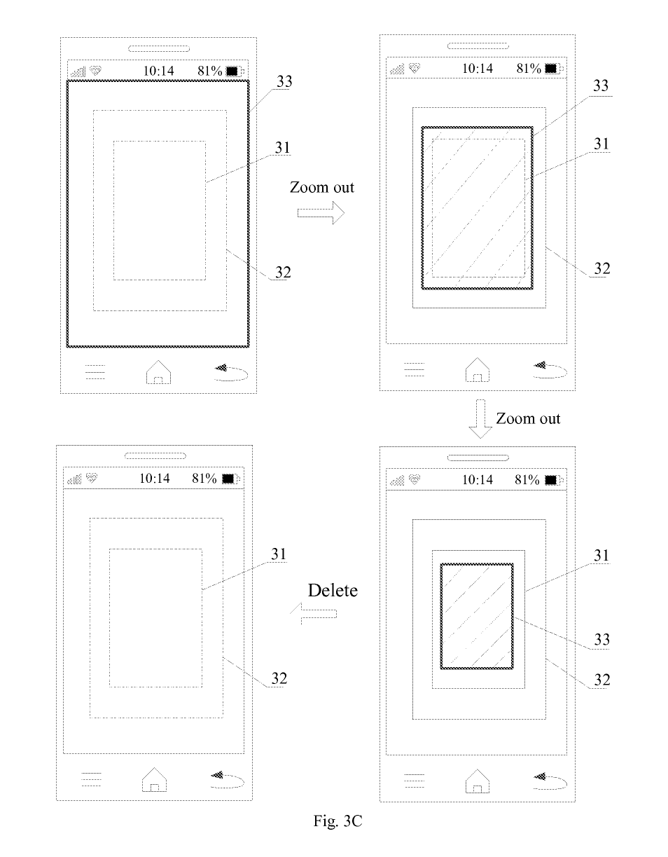

In another implementation scenario of image deletion, two concentric prompt boxes may be presented on the screen. When the image is zoomed out to be inside the larger one of the prompt boxes but outside the smaller one of the prompt boxes, even if the deleting condition is satisfied, the image is not directly deleted. When the image is zoomed out to be inside the smaller one of the prompt boxes and the deleting condition is satisfied, the image is directly deleted. For details, refer to the specific description regarding FIG. 3A.

FIG. 3A is a flow chart of a method for image deletion according to exemplary embodiments. As shown in FIG. 3A, the method for image deletion may include the following steps implemented in a device.

In step 301, when an image is displayed in a full-screen mode, the device determines whether the image is editable.

If the image is displayed in the full-screen mode and is permitted to be edited, it means that the image may be operated, for example, may be zoomed out, moved, etc.

In step 302, if a determining result is that the device has an editing permission to edit the image, the device present a first object and a second object presented on the screen.

Here, the first object may include a first prompt box having an area smaller than an area of the screen, the second object may include a second prompt box that is concentric with the first prompt box and larger than the first prompt box.

Generally, the first prompt box and the second prompt box are smaller than the image displayed in the full-screen mode, and may be at least partially behind the image displayed on the screen. The first prompt box and the second prompt box may be completely behind the image displayed in the full-screen mode from the beginning. In that case, both the first prompt box and the second prompt box are invisible from the screen.

FIG. 3B is a schematic diagram of a first object and a second object presented on a screen according to exemplary embodiments. The second object is presented while the first object is still presented on the screen. As shown in FIG. 3B, the first object may include a box denoted by a dash line, the first prompt box 31. The second object may include the second prompt box 32. The dash line denotes that the first prompt box 31 and the second prompt box 32 are behind the full-screen image 33 (in order to show the positional relationship between the image 33 and first and second prompt boxes 31, 32, pixel contents in the image 33 are omitted). At this time, the first prompt box 31 and the second prompt box 32 are invisible. Obviously, the second prompt box 32 and the first prompt box 31 are concentric prompt boxes, the second prompt box 32 has an area larger than that of the first prompt box, but smaller than that of the screen.

In practical implementation, since the image generally has a rectangular shape, each of the first prompt box and the second prompt box may also have a rectangular shape. Obviously, each of the first prompt box and the second prompt box may have other shapes such as an elliptical shape or a polygonal shape. The shapes of the first prompt box or the second prompt box are not specifically restricted in the embodiments.

It should be noted that, since the first prompt box and the second prompt box are concentric prompt boxes, the first prompt box and the second prompt box have the same shapes. Obviously, the purpose for setting the first prompt box and the second prompt box as concentric prompt boxes is to ensure that the image may be located inside the second prompt box and inside the first prompt box. The first prompt box and the second prompt box may have different shapes. However, it needs to be ensured that when the image is zoomed out, the image may be located inside the second prompt box and inside the first prompt box.

Alternatively or additionally, the first prompt box and the second prompt box may be presented at a central position of the screen, that is, each of the first prompt box and the second prompt box has a central position coinciding with the central position of the screen. Obviously, the first prompt box and the second prompt box may be at a position other than the central position of the screen. The specific positions of the first prompt box and the second prompt box are not restricted in the embodiments.

In step 303, when the image is outside the second prompt box, a property of the image is set as a normal state, and the image is displayed with a third display effect. The normal state is configured to indicate that deletion of the image having the property of the normal state is disabled.

The third display effect may be set in any form. Alternatively or additionally, the third display effect may be a default display effect when the image is in an editable state. The third display effect is not specifically restricted in the present disclosure.

When the image is editable and is outside the second prompt box, the property of the image is set as the normal state. In the normal state, deletion of the image is disabled. That is, the normal state is configured to indicate that deletion of the image having the property of the normal state is disabled. In other words, when the image is outside the second prompt box and is editable, if a user operates on the image and the user's fingers leave the screen or the image satisfies other deleting conditions, the image is not deleted, and a default operation is performed.

In step 304, the device receives a zoom-out operation signal, and the device may display the zoomed-out image on the screen. The zoom-out operation signal is generated when the screen is touched according to a predetermined track.

The zoom-out operation signal may be generated when a user touches the screen according to a predetermined track. In practical application, the zoom-out operation signal may be generated when the user touches the screen with two fingers according to a predetermined track.

For example, the zoom-out operation signal may be generated when the user touches the screen by moving two fingers toward each other according to a predetermined track. That is, the user may touch the screen simultaneously with the two fingers, and the touch points of the two fingers on the screen become gradually closer. Still referring to FIG. 2C, the description is not repeated here.

Obviously, the zoom-out operation signal may also be generated when the user touches the screen with one, two or four fingers according to other predetermined tracks. The generation manner of the zoom-out operation signal is not restricted in the present disclosure.

In step 305, when the image is zoomed out to be inside the second prompt box but outside the first prompt box according to the zoom-out operation signal, the device changes the property of the image into a to-be-deleted state, where the image is displayed with a fourth display effect in the to-be-deleted state. The to-be-deleted state is configured to indicate that direct deletion of the image having the property of the to-be-deleted state is disabled when the image satisfies the deleting condition.

The deleting condition is that a deleting signal is received, or a time period since the image is zoomed out to be inside the first prompt box reaches a predetermined time period.

The deleting signal is generated when the screen is changed from a state in which the screen is touched to a state in which the screen is not touched. In other words, since during the process of zooming out the image, the screen is always being touched, the deleting signal is generated when the user's fingers leave the screen from touching the screen.

In order to make a user easily learn about that the property of the image is the to-be-deleted state, the image in the to-be-deleted state may be displayed with the fourth display effect. For example, the image in the to-be-deleted state may be displayed with a highlighted effect or a blurred effect.

In order to avoid an inadvertent operation by the user, when the image is zoomed out to be inside the second prompt box but outside the first prompt box according to the zoom-out operation signal, the property of the image is changed into the to-be-deleted state. In the to-be-deleted state, even if the image satisfies the deleting condition, it is unable to directly delete the image.

In step 306, the device determines whether the image satisfies the deleting condition.

When the image is zoomed out to be inside the second prompt box but outside the first prompt box according to the zoom-out operation signal, the device determines whether the deleting condition is satisfied. For example, when the image is inside the second prompt box but outside the first prompt box, whether the user's finger(s) leave the screen is determined at this time, or whether the time period during which the image is inside the second prompt box but outside the first prompt box reaches the predetermined time period is determined

In step 307, if it is determined that the image satisfies the deleting condition, the device display a prompt message on the screen. The prompt message is configured to prompt a user to select whether to delete the image.

When the image is inside the second prompt box but outside the first prompt box, if it is determined that the deleting condition is satisfied, a prompt message is displayed. That is, when the image is inside the second prompt box but outside the first prompt box, the property of the image is the to-be-deleted state at this time. If the image satisfies the deleting condition, that is, if the user's fingers leave the screen or the image is kept inside the second prompt box but outside the first prompt box for the predetermined time period, the prompt message is displayed. In other words, in the case where the image is inside the second prompt box but outside the first prompt box, even if the user's fingers leave the screen or the image is kept inside the second prompt box but outside the first prompt box for the predetermined time period, the image is not directly deleted, so as to avoid inadvertent operation by the user.

The user may select whether to delete the image according to the prompt message.

Alternatively or additionally, when the image is zoomed out to be inside the second prompt box but outside the first prompt box and the image satisfies the deleting condition, the prompt message may be popped out. The prompt message is configured to prompt a user to select whether to delete the image. When a deleting instruction indicating that the user selects to delete the image is received, the image is deleted.

In step 308, if it is determined that the image does not satisfy the deleting condition, zooming-out of the selected image displayed on the screen is continued.

When the image is inside the second prompt box but outside the first prompt box, if the image does not satisfy the deleting condition, for example, the deleting signal is not received, and at this time, the zoom-out operation signal is kept being received, zooming-out of the selected image displayed on the screen is continued.

In step 309, when the image is zoomed out to be inside the first prompt box, the device changes the property of the image into a deletion state, where the image is displayed with a fifth display effect. The deletion state is configured to indicate that the image having the property of the deletion state is to be directly deleted when the image satisfies the deleting condition

When the image is zoomed out to be inside the first prompt box according to the zoom-out operation signal, the property of the image is changed into the deletion state. In the deletion state, it is allowed to directly delete the image when the image satisfies the deleting condition.

In order to make a user easily learn about that the property of the image is the deletion state, the image in the deletion state may be displayed with the fifth display effect. For example, the image in the deletion state may be displayed with a more deeply highlighted effect or a more deeply blurred effect than the fourth display effect. In this way, the user may determine whether to delete the image after the image is displayed with the fifth display effect.

In step 310, when the image is zoomed out to be inside the first prompt box and satisfies a deleting condition, the device deletes the image.

That is, when the image is zoomed out to be inside the first prompt box, and when the user' fingers leave the screen from touching the screen, the electronic device determines that the deleting condition is satisfied, and deletes the image at this time. Or, when a time period when the image is zoomed out to be inside the first prompt box and the image is kept inside the first prompt box reaches a predetermined time period, the electronic determines that the deleting condition is satisfied, and the image is deleted at this time.

It may be seen from above that, if a user intends to delete the image displayed in the full-screen mode, he may touch and slide on the screen with his two fingers to zoom out the image to be inside the first prompt box, then the user's two fingers leave the screen, and the image is deleted consequently. Or, the user may touch and slide on the screen with his two fingers to zoom out the image to be inside the first prompt box, keep the image inside of the first prompt box for the predetermined time period, and the image is deleted consequently. To delete an image displayed in a full-screen mode, the user may only need to touch and slide on the screen according to the predetermined track corresponding to the zoom-out operation signal and then make his fingers leave the screen, or, the may user only need to touch and slide on the screen according to the predetermined track corresponding to the zoom-out operation signal and then keep the image inside the first prompt box for the predetermined time period. The operation is simple without unnecessary button-pressing operations, and thereby image deletion is easy to implement.

For example, FIG. 3C is a schematic diagram showing image deletion according to exemplary embodiments. As shown in FIG. 3C, the first prompt box 31 and the second prompt box 32 are presented on the screen (invisible at an initial time), the image 33 is displayed in a full-screen mode. When the image 33 is zoomed out to be inside the second prompt box 32 but outside the first prompt box 31 by touch of the screen through user's fingers, the image 33 is displayed with the highlighted effect. At this time, if the user's fingers leave the screen, the prompt message is displayed; if the user's fingers do not leave the screen and zooming-out of the image 33 is continued, when the image 33 is zoomed out to be inside the first prompt box 31, the user's fingers leave the screen at this time, and the image 33 is deleted.

It should be further noted that, after the image is deleted, the presented first prompt box and the second prompt box may not be displayed any more, or the first prompt box and the second prompt box may be removed in order to prevent the user from deleting a next image inadvertently. Still referring to FIG. 3C, in order to indicate that the image 33 is deleted, the first prompt box 31 and the second prompt box 32 denoted by the dash lines are kept in the drawing after the image 33 is deleted. In practical application, after the image 33 is deleted, the first prompt box 31 and the second prompt box 32 may not be displayed on the screen any more. Thus, the first and second objects may be set to be invisible after the image 33 is deleted.

In another possible implementation scenario, when the image is zoomed out to be inside the first prompt box, a deleting prompt message is popped out. The deleting prompt message is configured to prompt that the image is to be deleted when the screen is changed from a state in which the screen is touched to a state in which the screen is not touched, or to prompt that the image is to be deleted after the predetermined time period is reached. In this way, the deleting prompt message may provide a deleting guide for the user, prompting the user to release the screen to delete the image according to the deleting prompt message, or to keep the image inside the first prompt box for the predetermined time to delete the image. Thereby, it is ensured that the user may be provided with more prompt messages and more options in image deletion, so as to improve user experience.

Accordingly, in the method for image deletion provided by the embodiments of the present disclosure, concentric first prompt box and second prompt box are presented on the screen when displaying the image in a full-screen mode, and when the image is zoomed out to be inside the second prompt box but outside the first prompt box, even if the deleting condition is satisfied, the image is not directly deleted, and the image is deleted when the image is zoomed out to be inside the first prompt box and the deleting condition is satisfied. Since the image is deleted as long as the image is zoomed out to be inside the first prompt box by touch of the screen and satisfies the deleting condition, there is no need to tap various buttons involved in deletion of the image. Thus, the method may solve the problem that during image deletion, a user needs to tap too many buttons and the position of each tap is different, thereby resulting in rather troublesome operations. Consequently, the method reduces the operation difficulty greatly, and thereby the deletion operation becomes simple and easy.

In the method for image deletion provided by the embodiments of the present disclosure, when the image is outside the second prompt box, is inside the second prompt box but outside the first prompt, or is inside the first prompt box, the image is displayed with different display effects so as to make a user easily distinguish which state the image is in, and when an image is in the deletion state, the image may be directly deleted. Therefore, inadvertent operations may be effectively reduced.

In the method for image deletion provided by the embodiments of the present disclosure, when the image is zoomed out to be inside the first prompt box, a deleting prompt message is popped out to prompt the user that the image is to be deleted when he releases touch on the screen, or to prompt the user that the image is to be deleted after the predetermined time period is reached. The user selects whether to delete the image according to the deleting prompt message. If deletion of the image is not continued, the screen may be kept touched, or the image may be zoomed in to be outside the first prompt box, thereby it may be ensured that the user may be provided with more prompt messages and more options in image deletion so as to improve user experience.

The following are device embodiments of the present disclosure, which may be configured to perform the method embodiments of the present disclosure. For details that are not disclosed in the device embodiments of the present disclosure, reference may be made to the method embodiments of the present disclosure.

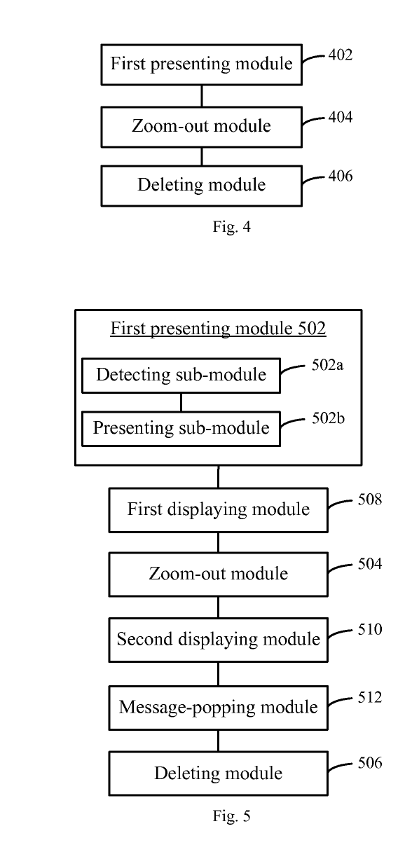

FIG. 4 is a block diagram of a device for image deletion according to exemplary embodiments. As shown in FIG. 4, the device for image deletion includes but not limited to: a first presenting module 402, a zoom-out module 404 and a deleting module 406.

The first presenting module 402 is configured to, when an image is displayed in a full-screen mode, present a first prompt box on a screen. The first prompt box has an area smaller than an area of the screen.

The zoom-out module 404 is configured to receive a zoom-out operation signal, and zoom out the image displayed on the screen. The zoom-out operation signal is generated when the screen is touched according to a predetermined track.

The deleting module 406 is configured to, when the image is zoomed out by the zoom-out module 404 to be inside the first prompt box presented by the first presenting module 402 and satisfies a deleting condition, delete the image.

Accordingly, in the device for image deletion provided by the embodiments of the present disclosure, an image is deleted when the image is zoomed out to be inside a presented first prompt box and satisfies a deleting condition. Since the image is deleted as long as the image is zoomed out to be inside the first prompt box by touch of the screen and user's fingers leave the screen, there is no need to tap various buttons involved in deletion of the image. Thus, the device may solve the problem that during image deletion, a user needs to tap too many buttons and the position of each tap is different, thereby resulting in rather troublesome operations. Consequently, the present disclosure reduces the operation difficulty greatly, and thereby the deletion operation becomes simple and easy.

FIG. 5 is a block diagram of a device for image deletion according to exemplary embodiments. As shown in FIG. 5, the device for image deletion includes but not limited to: a first presenting module 502, a zoom-out module 504 and a deleting module 506.

The first presenting module 502 is configured to, when an image is displayed in a full-screen mode, present a first prompt box on the screen. The first prompt box has an area smaller than an area of the screen.

The zoom-out module 504 is configured to receive a zoom-out operation signal, and zoom out the image displayed on the screen. The zoom-out operation signal is generated when the screen is touched according to a predetermined track.

The deleting module 506 is configured to, when the image is zoomed out by the zoom-out module 504 to be inside the first prompt box presented by the first presenting module 502 and satisfies a deleting condition, delete the image.

In a possible implementation, the device further may include: a first displaying module 508 and a second displaying module 510.

The first displaying module 508 is configured to set a property of the image as a normal state and display the image with a first display effect when the image is outside the first prompt box. The normal state is configured to indicate that deletion of the image having the property of the normal state is disabled.

The second displaying module 510 is configured to change the property of the image into a deletion state and display the image with a second display effect when the image is zoomed out to be inside the first prompt box. The deletion state is configured to indicate that the image having the property of the deletion state is to be directly deleted when the image satisfies the deleting condition.

In a possible implementation, the first presenting module 502 may include: a determining sub-module 502a and a presenting sub-module 502b.

The determining sub-module 502a is configured to determine whether the device has a permission to edit the image.

The presenting sub-module 502b is configured to, if a determining result of the determining sub-module 502a is that the image may be edited, present the first prompt box on the screen.

In a possible implementation, the deleting condition is: a deleting signal is received, or a time period since the image is zoomed out to be inside the first prompt box reaches a predetermined time period, the deleting signal being generated when the screen is changed from a state in which the screen is touched to a state in which the screen is not touched.

In a possible implementation, the device may further include: a message-popping module 512.

The message-popping module 512 is configured to, when the image is zoomed out by the zoom-out module 404 to be inside the first prompt box by the first presenting module 502, pop out a deleting prompt message. The deleting prompt message is configured to prompt that the image is to be deleted when the screen is changed from a state in which the screen is touched to a state in which the screen is not touched, or to prompt that the image is to be deleted after the predetermined time period is reached.

Accordingly, in the device for image deletion provided by the embodiments of the present disclosure, a first prompt box is presented on the screen when an image is displayed in a full-screen mode, and the image is deleted when the image is zoomed out to be inside the presented first prompt box and the deleting condition is satisfied. Since the image is deleted as long as the image is zoomed out to be inside the first prompt box by touch of the screen and user's fingers leave the screen, there is no need to tap various buttons involved in deletion of the image. Thus, the device may solve the problem that during image deletion, a user needs to tap too many buttons and the position of each tap is different, thereby resulting in rather troublesome operations. Consequently, the device reduces the operation difficulty greatly, and thereby the deletion operation becomes simple and easy.

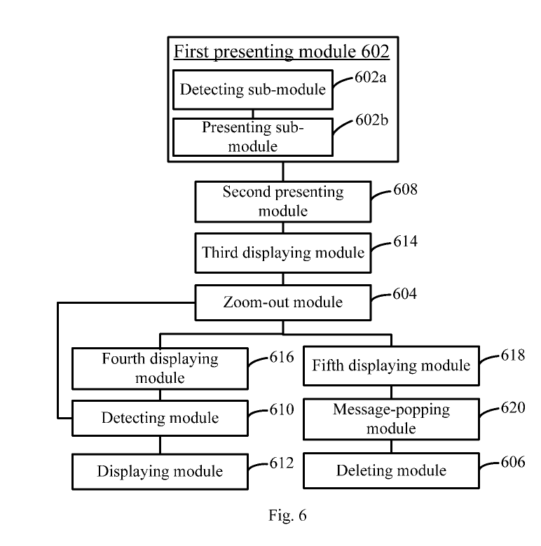

FIG. 6 is a block diagram of a device for image deletion according to exemplary embodiments. As shown in FIG. 6, the device for image deletion includes but not limited to: a first presenting module 602, a zoom-out module 604 and a deleting module 606.

The first presenting module 602 is configured to, when an image is displayed in a full-screen mode, present a first prompt box on a screen. The first prompt box has an area smaller than an area of the screen.

The zoom-out module 604 is configured to receive a zoom-out operation signal, and zoom out the image displayed on the screen. The zoom-out operation signal is generated when the screen is touched according to a predetermined track.

The deleting module 606 is configured to, when the image is zoomed out by the zoom-out module 604 to be inside the first prompt box presented by the first presenting module 602 and satisfies a deleting condition, delete the image.

In a possible implementation, the device may further include: a second presenting module 608, a determining module 610 and a displaying module 612.

The second presenting module 608 is configured to, when the first presenting module 602 presents the first prompt box on the screen, present a second prompt box on the screen. The second prompt box is concentric with the first prompt box and larger than the first prompt box.

The determining module 610 is configured to, when the image is zoomed out to be inside the second prompt box but outside the first prompt box according to the zoom-out operation signal, determine whether the image satisfies the deleting condition.

The displaying module 612 is configured to, if the determining module 610 determines that the image satisfies the deleting condition, display a prompt message. The prompt message is configured to prompt a user to select whether to delete the image.

The zoom-out module 604 is configured to, if the determining module 610 determines that the image does not satisfy the deleting condition, continue to perform the step of zooming out the image displayed on the screen.

In a possible implementation, the device may further include: a third displaying module 614, a fourth displaying module 616 and a fifth displaying module 618.

The third displaying module 614 is configured to, when the image is outside the second prompt box, set a property of the image as a normal state, and display the image with a third display effect. The normal state is configured to indicate that deletion of the image having the property of the normal state is disabled.

The fourth displaying module 616 is configured to, when the image is zoomed out to be inside the second prompt box but outside the first prompt box, change the property of the image into a to-be-deleted state, and display the image with a fourth display effect. The to-be-deleted state is configured to indicate that direct deletion of the image having the property of the to-be-deleted state is disabled when the image satisfies the deleting condition.

The fifth displaying module 618 is configured to, when the image is zoomed out to be inside the first prompt box, change the property of the image into a deletion state, and display the image with a fifth display effect. The deletion state is configured to indicate that the image having the property of the deletion state is to be directly deleted when the image satisfies the deleting condition.

In a possible implementation, the first presenting module 602 may include: a determining sub-module 602a and a presenting sub-module 602b.

The determining sub-module 602a is configured to determine whether the device has a permission to edit the image.

The presenting sub-module 602b is configured to, if a determining result of the determining sub-module 602a is that the image may be edited, present the first prompt box on the screen.

In a possible implementation, the deleting condition is: a deleting signal is received, or a time period since the image is zoomed out to be inside the first prompt box reaches a predetermined time period, the deleting signal being generated when the screen is changed from a state in which the screen is touched to a state in which the screen is not touched.

In a possible implementation, the device may further include:

a message-popping module 620, configured to, when the image is zoomed out by the zoom-out module 604 to be inside the first prompt box presented by the first presenting module 602, pop out a deleting prompt message. The deleting prompt message is configured to prompt that the image is to be deleted when the screen is changed from a state in which the screen is touched to a state in which the screen is not touched, or to prompt that the image is to be deleted after the predetermined time period is reached.

Accordingly, in the device for image deletion provided by the embodiments of the present disclosure, concentric first prompt box and second prompt box are presented on the screen when an image is displayed in a full-screen mode, and when the image is zoomed out to be inside the second prompt box but outside the first prompt box, even if the deleting condition is satisfied, the image is not directly deleted. The image is directly deleted when the image is zoomed out to be inside the first prompt box and the deleting condition is satisfied. Since the image is deleted as long as the image is zoomed out to be inside the first prompt box by touch of the screen and user's fingers leave the screen, there is no need to tap various buttons involved in deletion of the image. Thus, the device may solve the problem that during image deletion, a user needs to tap too many buttons and the position of each tap is different, thereby resulting in rather troublesome operations. Consequently, the device reduces the operation difficulty greatly, and thereby the deletion operation becomes simple and easy.

In the device for image deletion provided by the embodiments of the present disclosure, when the image is outside the second prompt box, is inside the second prompt box but outside the first prompt, or is inside the first prompt box, the image is displayed with different display effects so as to make the user easily distinguish which state the image is in, and when the image is in the deletion state, the image may be directly deleted. Therefore, inadvertent operations may be effectively reduced.

In the device for image deletion provided by the embodiments of the present disclosure, when the image is zoomed out to be inside the first prompt box, a deleting prompt message is popped out, to prompt the user that the image is to be deleted when he releases the screen, or to prompt the user that the image is to be deleted after the predetermined time period is reached. The user selects whether to delete the image according to the deleting prompt message. If deletion of the image is not continued, the screen may be kept touched, or the image may be zoomed in to be outside the first prompt box, thereby it may be ensured that the user may be provided with more prompt messages and more options in image deletion so as to improve user experience.

With respect to the devices in the above embodiments, specific operations performed by each modules have been described in detail in the embodiments of related method, and detailed description are omitted herein.

The embodiments of the present disclosure provide a device for image deletion which is capable of implementing the method for image deletion. The device for image deletion includes: a processor; and a memory for storing instructions executable by the processor;

wherein the processor is configured to perform:

when displaying an image in a full-screen mode, presenting a first prompt box on a screen, the first prompt box having an area smaller than an area of the screen;

receiving a zoom-out operation signal, and zooming out the image displayed on the screen, the zoom-out operation signal being generated when the screen is touched according to a predetermined track; and

when the image is zoomed out to be inside the first prompt box and satisfies a deleting condition, deleting the image.

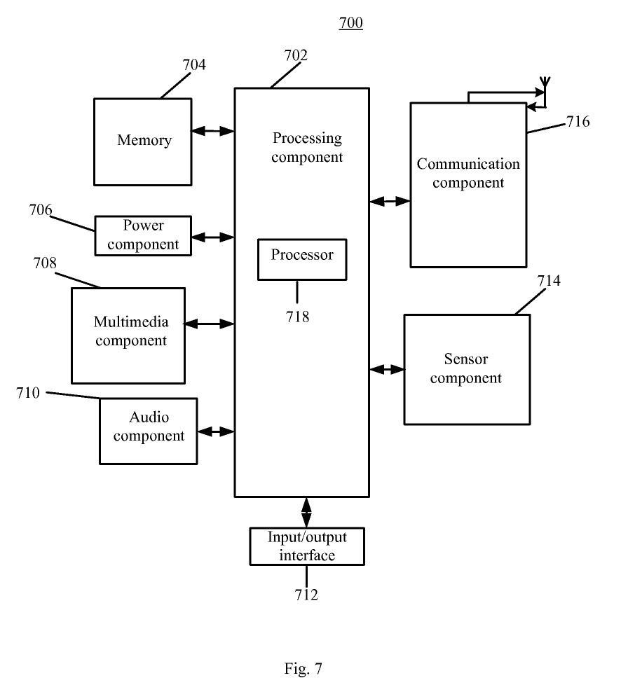

FIG. 7 is a block diagram of a device for image deletion according to exemplary embodiments. For example, the device 700 may be a mobile phone, a computer, a digital broadcast terminal, a messaging device, a gaming console, a tablet, a medical device, exercise equipment, a personal digital assistant, and the like. The methods disclosed above may be at least partially implemented in the device 700.

Referring to FIG. 7, the device 700 may include one or more of the following components: a processing component 702, a memory 704, a power component 706, a multimedia component 708, an audio component 710, an input/output (I/O) interface 712, a sensor component 714, and a communication component 716.

The processing component 702 typically controls overall operations of the device 700, such as the operations associated with display, telephone calls, data communications, camera operations, and recording operations. The processing component 702 may include one or more processors 720 to execute instructions to perform all or part of the steps in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operation of the device 700. Examples of such data include instructions for any applications or methods operated on the device 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the device 700. The power component 706 may include a power management system, one or more power sources, and any other components associated with the generation, management, and distribution of power in the device 700.

The multimedia component 708 includes a screen providing an output interface between the device 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and the rear camera may receive an external multimedia datum while the device 700 is in an operation mode, such as a photographing mode or a video mode. Each of the front camera and the rear camera may be a fixed optical lens system or have focus and optical zoom capability.

The audio component 710 is configured to output and/or input audio signals. For example, the audio component 710 includes a microphone (“MIC”) configured to receive an external audio signal when the device 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The sensor component 714 includes one or more sensors to provide status assessments of various aspects of the device 700. For instance, the sensor component 714 may determine an open/closed status of the device 700, relative positioning of components, e.g., the display and the keypad, of the device 700, a change in position of the device 700 or a component of the device 700, a presence or absence of user contact with the device 700, an orientation or an acceleration/deceleration of the device 700, and a change in temperature of the device 700. The sensor component 714 may include a proximity sensor configured to determine the presence of nearby objects without any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor.

The communication component 716 is configured to facilitate communication, wired or wirelessly, between the device 700 and other devices. The device 700 can access a wireless network based on a communication standard, such as WiFi, 2G, or 3G, or a combination thereof. In one exemplary embodiment, the communication component 716 receives a broadcast signal or broadcast associated information from an external broadcast management system via a broadcast channel. In one exemplary embodiment, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 700 may be implemented by circuitries including one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above method for image deletion. The modules and sub-modules may be implemented by the one or more circuitries.

In exemplary embodiments, there is also provided a non-transitory computer-readable storage medium including instructions, such as included in the memory 704, executable by the processor 720 in the device 700, for performing the methods for image deletion. For example, the non-transitory computer-readable storage medium may be a ROM, a RAM, a CD-ROM, a magnetic tape, a floppy disc, an optical data storage device, and the like.

The technical solutions provided by the embodiments of the present disclosure may have the following advantageous effects:

An image is deleted when the image is zoomed out to be inside a presented first object and satisfies a deleting condition. Since the image is deleted as long as the image is zoomed out to be inside the first object by touch of the screen and satisfies the deleting condition, there is no need to tap various buttons involved in deletion of the image. Thus, the present disclosure solves the problem that during image deletion. Users do not need to tap too many buttons on different positions on the screen to delete an image. Consequently, the present disclosure reduces the operation difficulty greatly, and thereby the deletion operation becomes very convenient.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact embodiments that has been described above and illustrated in the accompanying drawings, and that various modifications and changes can be made without departing from the scope thereof. It is intended that the scope of the invention only be limited by the appended claims.

What is claimed is:

1. A method for image deletion, comprising:
when displaying an image in a full-screen mode, presenting, by a device comprising a processor and a touch screen, a first object on the screen hidden under the displayed image, the first object having an area smaller than an area of the screen;
receiving, by the device, a zoom-out operation signal when the screen is touched according to a predetermined track;
zooming out the image displayed on the screen; and
deleting the image from the device when the image is zoomed out to be at least partially inside the first object and satisfies a deleting condition.

2. The method according to claim 1, further comprising:
presenting a second object on the screen while still presenting the first object on the screen, the second object being concentric with the first object and larger than the first object; and
determining whether the image satisfies the deleting condition when the image is zoomed out to be inside the second object but outside the first object in response to the zoom-out operation signal; wherein:
if the image satisfies the deleting condition, displaying a prompt message, the prompt message being configured to prompt a user to select whether to delete the image; and
if the image does not satisfy the deleting condition, continuing to perform the step of zooming out the image displayed on the screen.

3. The method according to claim 1, further comprising:
when the image is outside the first object, setting a property of the image as a normal state, and displaying the image with a first display effect, the normal state being configured to indicate that deletion of the image having the property of the normal state is disabled; and
when the image is zoomed out to be inside the first object, changing the property of the image into a deletion state, and displaying the image with a second display effect, the deletion state being configured to indicate that the image having the property of the deletion state is to be directly deleted when the image satisfies the deleting condition.

4. The method according to claim 2, further comprising:
when the image is outside the second object, setting a property of the image as a normal state, and displaying the image with a third display effect, the normal state being configured to indicate that deletion of the image having the property of the normal state is disabled;
when the image is zoomed out to be inside the second object but outside the first object, changing the property of the image into a to-be-deleted state, and displaying the image with a fourth display effect, the to-be-deleted state being configured to indicate that direct deletion of the image having the property of the to-be-deleted state is disabled when the image satisfies the deleting condition; and
when the image is zoomed out to be inside the first object, changing the property of the image to a deletion state, and displaying the image with a fifth display effect, the deletion state being configured to indicate that the image having the property of the deletion state is to be directly deleted when the image satisfies the deleting condition.

5. The method according to claim 1, wherein the presenting a first object on the screen, comprises:
determining whether the device has an permission to edit the image; and
if a determination result is that the image may be edited, presenting the first object on the screen.

6. The method according to claim 1, wherein the deleting condition comprises:
a deleting signal is received, or a time period since the image is zoomed out to be inside the first object reaches a predetermined time period, the deleting signal being generated when the screen is changed from a state in which the screen is touched to a state in which the screen is not touched.

7. The method according to claim 6, further comprising:
when the image is zoomed out to be inside the first object, popping out a deleting prompt message, the deleting prompt message being configured to prompt that the image is to be deleted when the screen is changed from a state in which the screen is touched to a state in which the screen is not touched, or to prompt that the image is to be deleted after the predetermined time period is reached.

8. A device for image deletion, comprising:
a processor; and
a memory for storing instructions executable by the processor;
wherein the processor is configured to perform:
when displaying an image in a full-screen mode, presenting a first object on the screen hidden under the displayed image, the first object having an area smaller than an area of the screen;
receiving a zoom-out operation signal when the screen is touched according to a predetermined track;
zooming out the image displayed on the screen; and
deleting the image when the image is zoomed out to be at least partially inside the first object and satisfies a deleting condition.

9. The device according to claim 8, wherein the processor is further configured to:
present a second object on the screen while the first object is presented on the screen, the second object being concentric with the first object and larger than the first object; and
determine whether the image satisfies the deleting condition when the image is zoomed out to be inside the second object but outside the first object according to the zoom-out operation signal; wherein:
if the image satisfies the deleting condition, display a prompt message, the prompt message being configured to prompt a user to select whether to delete the image; and
if the image does not satisfy the deleting condition, continue to perform the step of zooming out the image displayed on the screen.

10. The device according to claim 8, wherein the processor is further configured to:
when the image is outside the first object, set a property of the image as a normal state, and display the image with a first display effect, the normal state being configured to indicate that deletion of the image having the property of the normal state is disabled; and
when the image is zoomed out to be inside the first object, change the property of the image into a deletion state, and display the image with a second display effect, the deletion state being configured to indicate that the image having the property of the deletion state is to be directly deleted when the image satisfies the deleting condition.

11. The device according to claim 9, wherein the processor is further configured to:
when the image is outside the second object, set a property of the image as a normal state, and display the image with a third display effect, the normal state being configured to indicate that deletion of the image having the property of the normal state is disabled;
when the image is zoomed out to be inside the second object but outside the first object, change the property of the image into a to-be-deleted state, and display the image with a fourth display effect, the to-be-deleted state being configured to indicate that direct deletion of the image having the property of the to-be-deleted state is disabled when the image satisfies the deleting condition; and
when the image is zoomed out to be inside the first object, change the property of the image to a deletion state, and display the image with a fifth display effect, the deletion state being configured to indicate that the image having the property of the deletion state is to be directly deleted when the image satisfies the deleting condition.

12. The device according to claim 8, wherein the processor is configured to:
determine whether the device has a permission to edit the image; and
if a determination result is that the image may be edited, present the first object on the screen.

13. The device according to claim 8, wherein the deleting condition comprises:
a deleting signal is received, or a time period since the image is zoomed out to be inside the first object reaches a predetermined time period, the deleting signal being generated when the screen is changed from a state in which the screen is touched to a state in which the screen is not touched.

14. The device according to claim 13, wherein the processor is further configured to:
when the image is zoomed out to be inside the first object, pop out a deleting prompt message, the deleting prompt message being configured to prompt that the image is to be deleted when the screen is changed from a state in which the screen is touched to a state in which the screen is not touched, or to prompt that the image is to be deleted after the predetermined time period is reached.

15. A non-transitory readable storage medium comprising instructions, executable by a processor in a terminal, for performing acts comprising:
when displaying an image in a full-screen mode, presenting a first object on a screen hidden under the displayed image, the first object having an area smaller than an area of the screen;
receiving a zoom-out operation signal when the screen is touched according to a predetermined track;
zooming out the image displayed on the screen; and
deleting the image when the image is zoomed out to be inside the first object and satisfies a deleting condition.

16. The non-transitory readable storage medium according to claim 15, wherein the acts further comprises:
present a second object on the screen while the first object is still presented on the screen, the second object being concentric with the first object and larger than the first object; and
when the image is zoomed out to be inside the second object but outside the first object according to the zoom-out operation signal, determine whether the image satisfies the deleting condition; wherein:
if the image satisfies the deleting condition, display a prompt message, the prompt message being configured to prompt a user to select whether to delete the image; and
if the image does not satisfy the deleting condition, continue to perform the step of zooming out the image displayed on the screen.

17. The non-transitory readable storage medium according to claim 16, wherein the acts further comprises:
if it is determined that the image satisfies the deleting condition, displaying a prompt message, the prompt message being configured to prompt a user to select whether to delete the image; and
if it is determined that the image does not satisfy the deleting condition, continuing performing the step of zooming out the image displayed on the screen.

18. The non-transitory readable storage medium according to claim 17, wherein the acts further comprises:
when the image is outside the first object, setting a property of the image as a normal state, and display the image with a first display effect, the normal state being configured to indicate that deletion of the image having the property of the normal state is disabled; and
when the image is zoomed out to be inside the first object, changing the property of the image into a deletion state, and display the image with a second display effect, the deletion state being configured to indicate that the image having the property of the deletion state is to be directly deleted when the image satisfies the deleting condition.

19. The non-transitory readable storage medium according to claim 18, wherein the acts further comprises:
when the image is outside the second object, setting a property of the image as a normal state, and displaying the image with a third display effect, the normal state being configured to indicate that deletion of the image having the property of the normal state is disabled; and
when the image is zoomed out to be inside the second object but outside the first object, changing the property of the image into a to-be-deleted state, and displaying the image with a fourth display effect, the to-be-deleted state being configured to indicate that direct deletion of the image having the property of the to-be-deleted state is disabled when the image satisfies the deleting condition.

20. The non-transitory readable storage medium according to claim 19, wherein the acts further comprises:
when the image is zoomed out to be inside the first object, changing the property of the image to a deletion state, and displaying the image with a fifth display effect, the deletion state being configured to indicate that the image having the property of the deletion state is to be directly deleted when the image satisfies the deleting condition.
